(19) United States
(12) Patent Application Publication
(10) Pub. No.: US 2024/0084724 A1
(43) Pub. Date: Mar. 14, 2024

(54) Advanced And Full Flow Filtration Hybrid Filter Apparatus

(71) Applicant: Adan Reinosa, Montebello, CA (US)

(72) Inventor: Adan Reinosa, Montebello, CA (US)

(21) Appl. No.: 18/445,091

(22) Filed: Mar. 31, 2023

Related U.S. Application Data
(60) Provisional application No. 63/372,757, filed on Mar. 31, 2022.

(51) Int. Cl. F01M 11/03; B01D 29/11; B01D 29/52; B01D 29/96; B01D 35/00; B01D 35/147; B01D 39/10

(52) U.S. Cl. CPC F01M 11/03; B01D 29/11; B01D 29/52; B01D 29/96; B01D 35/005; B01D 35/147; B01D 39/10

(57) ABSTRACT

Vehicles or machinery equipped with full flow spin-on, canister or reusable filters can benefit by including advanced or bypass grade parallel filtration. Incorporating advanced filtration is generally difficult due to impractical lubrication system access, cramped engine bays, and some installation solutions require engine modifications and hardware. The hybrid filter apparatus of the present invention provides advanced filtration when used inside well-known manufactured forms of spin-on, cartridge, or reusable filters. The apparatus increases filtration efficiency, capacity, easier maintenance, while providing environmental benefits.

### BACKGROUND OF THE INVENTION

The present invention relates to apparatuses that provide full flow and complementary advanced fine filtration to engines or hydraulic systems.

### DESCRIPTION OF PRIOR ART

### Background

The benefits of Bypass Filtration, or Advanced Filtration, through research by the US Department of Energy through the Argonne Laboratory, SAE, and others, yield an impressive array of benefits, among them: increased oil service interval. extended full flow oil filter service interval, reduced emissions reduced, reduced friction and parasitic energy losses, lower engine overhaul costs, fuel efficiency gains, and environmental collateral benefits.

Many filtration devices have been invented avoiding extensive external hardware or delivering bypass grade filtration using external hardware and complicated setups. The present invention delivers the desired filtration by using a minimal design combination media using two media filter grades and harnessing natural and generated differential pressures for its operation.

Prior art examples are found in the following US patents: U.S. Pat. No. 2,407,190, to William O. Tait, for a Filter for fluid flow systems, U.S. Pat. No. 2,559,267 to Charles E. Winslow et al., for a Filter, U.S. Pat. No. 2,843,268 to Walter V. Kennedy, for a Combined Full-flow and part-flow oil filters, U.S. Pat. No. 3,021,954, to Allen Hoffman, for a Combination full-flow and by-pass filter, U.S. Pat. No. 3,021,955 to John Joyce, for a Filter unit with restrictor means, U.S. Pat. No. 4,058,459 to John W. Griffin, for a Liquid filter apparatus, U.S. Pat. No. 4,832,836 to Leslie Selsdon, for a Series filter, U.S. Pat. No. 7,090,773, to Meddock and Swanson for a Coaxial full-flow and bypass oil filter; U.S. Pat. No. 6,951,606, to Cousineau and Allen for an Auxiliary filtration system. More examples for combining full flow and high-density filtering have been integrated in one single unit, such as shown in Dahm, et al., U.S. Pat. No. 4,036,755. However, such a filtering system is not made in such a manner that is easily connected to the standard engine filtering system. Beardsley, U.S. Pat. No. 2,680,520 shows a full-flow and part-flow filter combination. It has the same inherent problems as the previously described full-flow and part-flow filters. These problems may be exhibited by a recently developed combination full flow and a bypass grade Teflon sintered disc, with a rather small loading area for the bypass section, generously estimated to be limited to a cross section of the spin-on combination filter, such as U.S. Pat. No. 6,605,215, to Assion for a Hybrid spin-on oil filter, and U.S. Pat. Nos. 7,048,848, 8,123,942, and 8,241,494 to Assion for, again, a Hybrid spin-on oil filter and similar configurations.

Other examples can be found in U.S. Pat. No. 6,666,968, to Smith et al. for a Fluid filtration apparatus; U.S. Pat. No. 5,843,284, to Waters et al. for Two-stage oil bypass filter device, U.S. Pat. No. 5,695,637, to Jiang et al. for a Combination full flow and bypass filter with venturi nozzle, U.S. Pat. No. 6,488,848 to Smith for a Cleanable filter with ported cylinder adjacent screen, U.S. Pat. No. 10,195,553 to Baxter for an Oil filter apparatus, U.S. Pat. No. 8,282,821 for an Oil filter assembly and associated filter element to Maier et al., U.S. Pat. No. 9,815,004 for a Filter with a liquid drain valve to Uhl, et al., and U.S. Pat. No. 6,322,697 for an Oil filter assembly to Hacker, et al.

Further examples of prior art include U.S. Pat. No. 2,843,268A, Fram Corp. for a Combined full-flow and part-flow oil filters; EP1108456A1, Nelson Industries, Inc. for a Combination full flow and bypass filter with venturi nozzle; U.S. Pat. No. 6,350,379B1, Dana Corporation for a Dual filter with flow mixer; U.S. Pat. No. 20030226795A1, Baldwin Filters, Inc., for an Environmentally friendly dual lube venturi filter cartridge; U.S. Pat. No. 6,761,822B1, Dana Corporation for a Dual filter with flow mixer and centrifugal separator; U.S. Pat. No. 20050126965A1, Meddock Leroy J. for a Coaxial full-flow and bypass oil filter; U.S. Pat. No. 20070261377A1 to Klug Jerry J for a Spin-on filter arrangement and methods; U.S. Pat. No. 20080078716A1 to Hepo Filters, Inc. for a Bypass oil filter system and method of installing same; U.S. Pat. No. 7,704,397B2 to Filtran LLC for a Coaxial full-flow and bypass oil filter having cap with blades; U.S. Pat. No. 7,704,396B2 to Filtran LLC for a Coaxial full-flow and bypass oil filter with spring/gasket arrangement; U.S. Pat. No. 3,021,955A to Purolator Products Inc. for a Filter unit with restrictor means; U.S. Pat. No. 4,869,820A to Gary Karlin for a Filter apparatus for fluids with co-axially stacked filter elements; EP0631803A1 to Fleetguard, Inc. for a Combination full flow and bypass filter with venturi nozzle; U.S. Pat. No. 30,226,795A1 to Baldwin Filters, Inc. for an Environmentally friendly dual lube venturi filter cartridge full-flow and bypass oil filter; U.S. Pat. No. 20050252838A1 to Baldwin Filters, Inc. for a Fluid filtration apparatus and method; U.S. Pat. No. 20060037906A1 to Assion Norbert for a Liquid filter assembly; U.S. Pat. No. 20060278570A1 to Meddock Leroy J. for a Coaxial full-flow and bypass oil filter apparatus and method; U.S. Pat. No. 9,109,478 to Reinosa for a Method and apparatus for a parallel bypass filtration system for internal combustion engines and similar systems U.S. Pat. No. 9,932,868B2 to Adan Reinosa for an Apparatus for providing fine filtration to hydraulic systems and internal combustion engines; U.S. Pat. No. 10,913,019 to Adan Reinosa and Laura M. Reinosa for an Apparatus for providing supplemental advanced filtration.

### SUMMARY OF THE INVENTION

The present invention, a combination full flow and advanced filtration apparatus in combination with well-known normally provided filter enclosures, has many advantages over previous art: quick and simple bolt-on installation, inexpensive to manufacture, a minimal design, quick and simple connection with no hydraulic conduits needed, no engine modifications needed, no need to encroach the limited engine bay space, quick and easy filter element replacement, no need for a parasitic oil flow or side stream oil from the engine or hydraulic system, and in one application the full flow filter is reusable, these attributes of the present invention solve disadvantages found in prior art traditional bypass systems.

In spin-on oil filter equipped engines or hydraulic systems, the hybrid filter element apparatus of the present invention, manufactured in combination with the well-known structure of a spin on oil filter, simply replaces the normal spin-on oil filter element and then attaches to the normally provided engine threaded oil filter stud point of attachment. In canister filters the hybrid filter element apparatus is manufactured to replace the well-known normally provided filter cartridge inside the normally provided canister housing. In the case of renewable filters, a reusable hybrid filter element apparatus, or a non-reusable hybrid filter element apparatus simply is replaced inside a well-known normally provided reusable filter enclosure.

The hybrid filter element apparatus is substantially shaped as a thick-walled cylinder having at least two filter sections: a full flow filter section, made with full flow filtering media; an advanced filtration section, bypass grade in old school parlance, made with a high efficiency advanced filtration filter media. The two sections are sealingly assembled axially to form a thick-walled cylinder.

The hybrid filter element apparatus is equipped with a downstream perforated inner tube disposed at a downstream hydraulic point of the advanced filtration media element and the full flow filter section. The inner tube is equipped with a plurality of flow control orifices whose collective area is designed to be smaller than the outlet flow area into the engine or system. This restriction forces, in part as a component of a net total differential pressure, the total flow to split into two flows: a larger flow that goes through the full flow filter element, a full flow to receive full flow filtration, and another, a smaller parallel flow, a continuum of peripheral flows around the high efficiency advanced filtration element, that are diverted, due to the pressure differential created in part by the tube orifices restriction, through a path that is forced to flow through the advanced filtration filter element. The parallel flows are further aided by differential pressure contributors such as the pressure differential created by the full flow upper element filter media as it loads and plugs during its service interval, inherent filter structures, inherent frictional and viscous flow losses, pump pressure fluctuations, temperature, among others.

The parallel flows across the advanced filtration element may be controlled by a plurality of flow control orifices, drilled around the inner tube, that limit the amount of flow though the advanced filtration element since the role of the lower filter is to slowly filter the oil at a higher filtering efficiency, not to perform the function of the full flow filter, the full flow filtration element.

Once the diverted oil goes through the lower filter advanced filtration filter media it rejoins the flow through said flow control orifices to reconstitute the total flow into the normally provided engine threaded engine oil filter stud, or canister point of discharge and into a lubrication gallery inlet of an engine or hydraulic system. The total flow into the engine is cleaned to a ratio of (Parallel Flows/Total Flow) during operation.

The hybrid filter element, comprised of at least two sections, is made to provide advanced filtration by having a set of differential pressures acting across the advanced filtration element and is generated during use, singly or in combination, by:
1. a flow restriction lip around the bottom edge of the full flow filter section, acting as a flow restriction, located at the full flow most upstream hydraulic point, the differential pressure is generated by reducing the annular flow area between the full flow filtration element and the filter enclosure internal wall, a first differential pressure contributor.
2. a perforated tube section located contiguous to the downstream side of the full flow section, calibrated to having a plurality of perforations whose collective area is within a range of 10% to 99% of a discharge downstream orifice flow area, as to create a differential pressure across the advanced filtration filter section, a second differential pressure contributor.
3. an orifice restriction located at the farthest downstream point of the full flow filter section and at a hydraulic point in the joining plane that sealingly joins the full flow filter section to the advanced filtration section, a third pressure differential contributor.
4. a natural flow restriction due to the full flow media, a variably increasing pressure as the full flow filter loads upon service, a fourth pressure differential contributor.
5. natural flow restrictions related to viscous losses, fluid flow constraints, temperature variations, fluid pressure changes, full flow media plugging back pressure, among others.

The net differential pressure promotes flow across the relatively tighter, when compared to the full flow filter element, advanced filtration media of the advanced filtration element. It is proper to point out at this point that using the traditional bypass media will not flow using the present invention strategy because the need of high pressure, and only when you recognize the unexpected fact that synthetic media can be used for bypass applications the present invention outperforms the traditional application of old school bypass filtration tight media.

The high efficiency cartridge filter element of the present invention works by design at a low pressure drop across its media element, less than 10 PSI. This is opposed to the traditional bypass filtration media systems requiring much higher than 10 PSI, due to its tight pore construction. The present invention uses synthetic microfibers, and it is therefore more energy efficient than traditional systems requiring said high-pressure gradient to effect flow across it. The ability of this synthetic media to offer a low resistance to flow has been largely gone unrecognized by the myopic and stubborn bypass filtration industry which is stuck in the mantra: “a bypass filter needs a high-pressure gradient to flow”. Bucking the trend of the industry, the present invention disproves this mantra by the unexpected result of flowing oil, or hydraulic fluid, across the synthetic media at low pressures. This unexpected observation and application opens the application of a minimum design such as is shown in the present invention. In fact, just placing the two sections in parallel without any other piece of hardware will eventually flow through the advanced filtration media as in the limit the differential pressure across the full flow filter increases as it loads with dirt and progressively plugs, thereby increasing the differential pressure across the advanced filtration media section.

It should be noted that this high efficiency media is not intended to perform the duty of a full flow filter therefore a plurality of flow limiting orifices may be provided to reduce or regulate the parallel oil flow across it. The key attribute that should be noted is that the filter media requires a low pressure, less than 10 PSI, as mentioned above as an unexpected benefit, to effect slow and steady flow across the media at all engine operating conditions, i.e.: across all RPM rotational and mechanical loading conditions, flowing even at idle oil pressures, usually 1 Bar (14.7 PSI) and across all pressures until redline RPM, as opposed to traditional bypass grade media systems that begins to effect flow at substantially higher RPM from idle RPM.

The hybrid filter element can also be designed such that the upper filter section is made using a reusable stainless-steel mesh, and the lower filter is just a replacement element, furthering its environmentally friendly function. A bypass valve, whose function is to open at a predetermined pressure, may also be provided should the combined filter elements, become plugged or obstructed to flow i.e.: due to very cold oil, plugged filters, allowing unfiltered oil into the engine to prevent engine damage when housed inside a spin-on filter form, reusable filter enclosure form, or canister filter form. The bypass valve is mentioned here for completeness as it is not part of the filter apparatus but it works in combination with it, but not essential.

The assembled unit, as in the spin on filter case and reusable filter case, simply screws in the point of connection of the normally provided threaded oil filter stud, all the plumbing associated with the traditional prior art bypass filter installation is eliminated, as is the energy and labor-intensive process of seeking for a pressure point and an oil return path back to the engine.

The high efficiency filter is desired to be within a range down to below one micron to 50 microns in cross-sectional area, and preferably made with synthetic filtering media or similar. It is also desirable to have said filter endowed with chemicals or/and additives that can be time released to lengthen the oil or hydraulic fluid service interval.

Given those reasons above, the present invention is more resourceful, functional, and its strategy of connection leads it to be more readily accepted by the buying public, saving time, labor, the environment, and our domestic natural resources.

### BRIEF DESCRIPTION OF THE DRAWINGS

FIG. 1 Is a cross section showing the main components, structures, and hydraulic flows of the hybrid filter apparatus inside a typical spin-on cylindrical filter envelope showing design features to achieve differential pressures.

FIG. 2 Is a comparison of the discharge flow area into the engine with and without the equivalent collective area flow control orifices whose collective area is designed to be smaller than the outlet flow area into the engine or system.

FIG. 3 Is a graph showing relationships between lubricant flows across the full flow filter section, the advanced filtration filter section, the differential pressures across both filter sections, and the effect of including a flow restrictor, and their behavior as miles accumulate until service interval is achieved.

FIG. 4 Is a frontal view of the perforated inner tube developed area showing the two sets of flow control orifices for the upper full flow filter section and the lower advanced filtration filter section and its effect on dirt loading patterns for the full flow filter section.

### DETAILED DESCRIPTION OF THE DRAWINGS

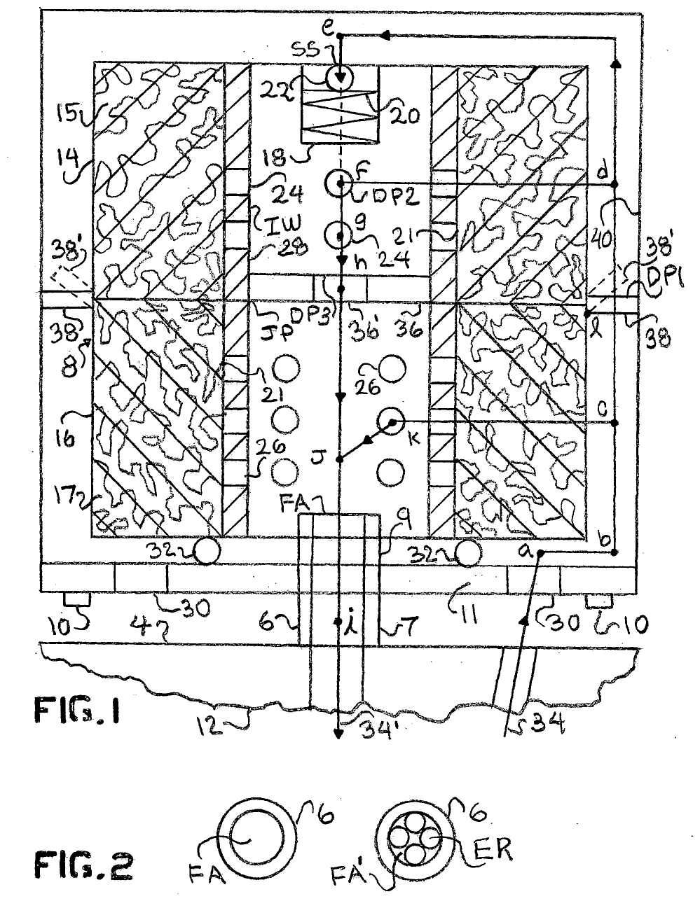

Referring to FIG. 1, a cross section showing the main components, structures, and hydraulic flows of a hybrid filter apparatus 8 disposed inside a typical spin-on filter 2, said hybrid filter apparatus 8 having an upper full flow filter section 14, made with a full flow filter media 15, and a lower advanced filtration filter section 16, made with preferably a synthetic microfiber advanced filtration media 17. The upper full flow filter section 14 and the lower advanced filtration filter section 16 are substantially shaped as a thick-walled cylinder, together sealingly abutted to each other along a joining plane JP to form the hybrid filter apparatus 8 which is substantially shaped as a thick walled cylinder.

Still referring to FIG. 1, the hybrid filter apparatus 8 is equipped with a perforated inner tube 28 disposed immediately downstream of the hybrid filter apparatus 8 along its natural central bore. The perforated inner tube 28 is provided with a flow gap 21, between the downstream side of the hybrid filter apparatus 8 and an internal wall IW of the perforated inner tube 28 through all its length as to allow filtered lubricant to flow through a plurality of full flow control orifices 24 and a plurality of advanced filtration control orifices 26.

Still referring to FIG. 1, it shows a flexible pressure biasing membrane 38 that abuts sealingly against an internal wall 40 of the spin-on filter 2 in a complete circumferential manner. The spin-on filter 2 affixes to an engine 12 which is normally provided with an oil filter stud 6, having a set of external threads 7 that match a set of internal threads 9 that are normally provided to a filter plate 11 of spin-on filter 2, where upon driving home the spin-on filter 2 by affixing it to the oil filter stud 6 it is now sealed against a normally provided engine sealing area 4 by a seal 10. Still referring to FIG. 1, the engine 12 during operation generates a lubricant flow 34 which is channeled through a set of filter orifices 30 to form a lubricant flow (a b c k j) that flows across the lower advanced filtration filter section 16 and a lubricant flow (a b c d f g h j) that flows across the upper full flow filter section 14, both flows join at a hydraulic point (j) to reconstitute the lubricant flow 34, shown as a lubricant flow (j i) which injects into the engine 12 as a reconstituted lubricant flow 34′ which is now cleansed to a ratio of (Lubricant flow across the lower advanced filtration filter section 16/Lubricant flow across the upper full flow filter section 14). The hybrid filter apparatus 8 is designed to have flow restrictors, singly or in combination, between hydraulic points (1) and (h), along a lubricant flow (1 d f h) for the apparatus to work. In the present example the flexible pressure biasing membrane 38, upon establishing lubricant flow 34 during engine 12 operation, is forced to move to a new position 38′ generating a first differential pressure contributor DP1 across the lower advanced filtration filter section 16, resulting in a lubricant flow (c k j).

Still referring to FIG. 1, the perforated inner tube 28 is equipped with said full flow control orifices 24 that collectively act as a restriction to lubricant flow (d f) generating a second differential pressure contributor DP2 whose net effect is to promote the lubricant flow (c k j) across the lower advanced filtration filter section 16. The single application of said full flow control orifices 24 to generate the differential pressure contributor DP2 is the preferred embodiment for the hybrid filter apparatus 8. This DP2 contributor is already in a well-known shape and it is easily adapted for manufacturing since filter elements already are made with a central tube so no special manufacturing processes need to be designed. Further, now referring to FIG. 4, the location of the full flow control orifices 24 in the developed internal surface of the perforated inner tube 28 contributes to the progressive increase of localized filter loading around the orifices in an outward direction 25 of the adjacent full flow filter media 15, creating as well an overlap loading areas 25′, which collectively increase the differential pressure across the full flow filter media 15 where the net effect to this invention is more available differential pressure across the lower advanced filtration filter section 16 as the full flow media 15 loads upon use. Now referring to FIG. 2, a comparison of a discharge flow area FA into the engine central to the oil filter stud 6 shown with and without an equivalent collective area flow control of eight full flow control orifices 24, drawn to scale per FIG. 1, whose collective area is designed to be smaller than the outlet flow area FA into the engine or system in order to effect the desired differential pressure DP2, shown in FIG. 1. A blocked flow area FA′ is shown which in this ease, drawn to scale, is approximately 67% of FA, which falls within the desired range between 1% and 90% of flow area FA blockage.

Now referring to FIG. 1, a restriction plate 36 is provided at the most downstream hydraulic point h of the upper full flow filter section 14, and at the level of the joining plane JP, and is equipped with an orifice restrictor 36′ whose flow area is chosen from a range of 10% to 99% of the flow area FA that acts as a restriction to flow (d f g h j) generating a third differential pressure contributor DP3 whose net effect is to promote the flow (c k j) across the lower advanced filtration filter section 16.

Still referring to FIG. 1, it shows a bypass valve 18 and its basic components of a bearing ball 22 biased against a sealing surface SS by a compressed spring 20. The bypass valve 18 is designed to open at a predetermined pressure, thereby establishing a lubricant flow (c de f) should the hybrid filter apparatus 8 were to become physically plugged or the temperature of the oil is so low that viscosity increases preclude a proper flow of the reconstituted lubricant flow 34′ to prevent oil starvation damage to the engine or hydraulic system. It should be noted that the bypass valve 18 is mentioned here for completeness and illustration as it is not a part of the hybrid filter apparatus 8 but works in cooperation with it in its three main applications and forms: spin-on oil filters, reusable oil filters, and cartridge oil filters.

Referring to FIG. 1, the following hybrid filter element apparatus 8 embodiments are possible with said differential pressure generators:
1. The hybrid filter element having just the upper full flow filter section 14 sealingly abutting the lower advanced filtration filter section 16 having only the differential pressure resulting from the upper full flow filter section 14 loading during use.
2. The hybrid filter apparatus 8 having the flexible pressure biasing membrane 38, using the differential pressure DP1.
3. The hybrid filter apparatus 8 having the perforated inner tube 28 and having the full flow control orifices 24 with a collective area in a range of 10% to 99% of the flow area FA, and the advanced filtration control orifices 26, this numeral 3 is the preferred embodiment for the use of the hybrid filter apparatus inside the spin-on, reusable, and cartridge filter forms, using the differential pressure DP2.
4. The hybrid filter apparatus 8 having the restriction plate 36, said plate 36 having the orifice restrictor 36′ whose flow area is chosen from a range of 10% to 99% of the flow area FA, using the differential pressure DP3.
5. The hybrid filter apparatus 8 using numerals 2 and 3 in combination.
6. The hybrid filter apparatus 8 using numerals 2 and 4 in combination.
7. The hybrid filter apparatus 8 using numerals 3 and 4 in combination.
8. The hybrid filter apparatus 8 using numerals 2, 3, and 4 in combination.

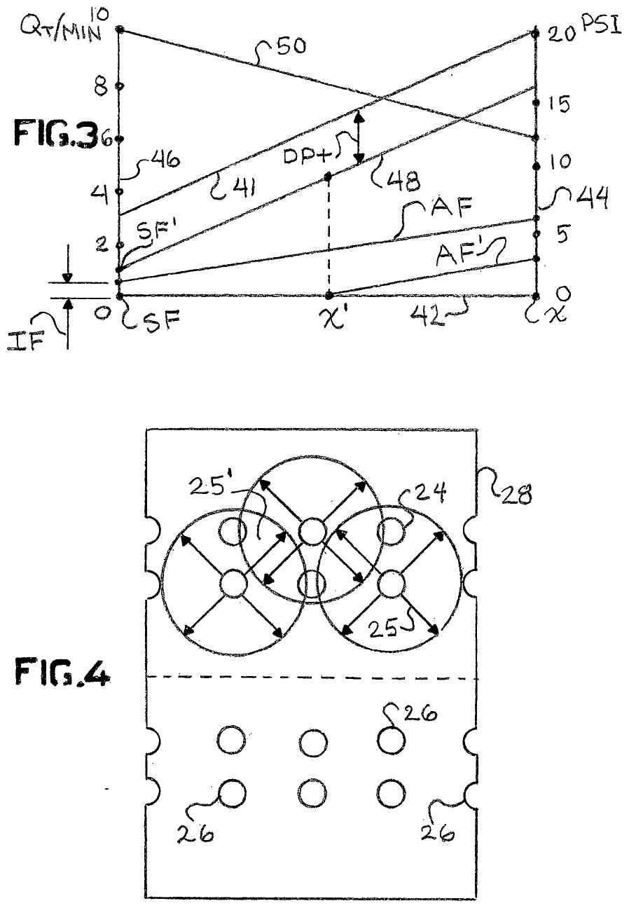

Now referring to FIG. 3, a representative graph showing relationships between lubricant flows, a lubricant flow 50 across the full flow filter section 14, a lubricant flow AF across the lower advanced filtration filter section 16, a differential pressure across both filter sections 48, and the effect of including a flow restrictor, singly or in combination, a boosted differential pressure 41. Inclusion of the generated differential pressures DP1, DP2, DP3, and others mentioned above, generates a boosted incremental pressure DP+ and their behavior as miles accumulate until service interval is achieved at an end of service interval X. Still referring to FIG. 3, in the absence of a generated differential pressure across the lower advanced filtration section 16 the flow of oil across is negligible until a point x′ is reached due to plugging of the upper full flow filter section 14. Inclusion of a differential pressure generator, singly or in combination, shifts point SF to a new point SF′ where a higher flow across the advanced filtration element is achieved from the beginning to the end of the filter service interval when compared to a lubricant flow line AF′ without any differential pressure generator, essentially shifting the lubricant flow line AF′ to the lubricant flow line AF, so that advanced filtration is achieved throughout the service interval. It is clear to those skilled in the art that the straight lines are representative of the flows and pressures in the device but for simplification are presented as straight lines.

It will be understood that each of the elements described above, or two or more together may also find a useful application in other types of methods differing from the type described above.

While certain novel features of this invention have been shown and described and will be pointed out in future claims, it is not intended to be limited to the details above, since it will be understood that various omissions, modifications, substitutions and changes in the forms and details of the device illustrated, and its operation can be made by those skilled in the art without departing in any way from the spirit of the present invention.

I claim:

1) An advanced and full flow filtration hybrid filter apparatus, said apparatus comprising:
an upper full flow filter section, said upper full flow filter section normally shaped as a thick-walled cylinder made with a full flow filter media having a top closed end and an upper full flow section bottom open end, said upper full flow filter section having an upper upstream external full flow filter surface and an upper downstream internal full flow filter surface,
a lower advanced filtration filter section, said lower advanced filtration filter section normally shaped as a thick-walled cylinder made with an advanced filtration media having a lower filter section top open end and, a lower filter section bottom open end, said lower advanced filtration filter section having a lower upstream external advanced filtration filter surface and a lower downstream internal advanced filtration filter surface,
a hybrid filter filtration element generated by having said upper full flow section bottom open end sealingly biased against said lower advanced filtration filter section top open end, said hybrid filter filtration element having an upstream filter surface, said hybrid filter filtration element having a downstream internal filter surface,
a perforated inner tube contiguously and sealingly disposed against said hybrid filtration element downstream internal filter surface, the perforated inner tube having a plurality of full flow restriction control orifices located contiguous to said upper downstream internal full flow filter surface and a plurality of advanced filtration restriction control orifices located contiguous to said lower downstream internal advanced filtration filter surface,
a spin on filter enclosure,
wherein during operation a normally provided engine lubricant flow is injected into said spin on filter enclosure splitting into a parallel full flow lubricant flow and a parallel advanced filtration lubricant flow, said parallel full flaw lubricant flow generating a first differential pressure contributor while flowing across said upper full flow filter section and a second differential pressure contributor while flowing through said plurality of full flow restriction control orifices, said first and said second differential pressure contributors thereby generating a net differential pressure across said lower advanced filtration filter section, said net differential pressure promoting said parallel advanced filtration lubricant flow across said lower advanced filtration filter section, said parallel full flow lubricant flow and said advanced filtration lubricant flow forming and returning a reconstituted engine lubricant flow to a normally provided engine discharge flow area whereby simultaneous full flow and advanced filtration of said normally provided engine lubricant flow is accomplished.

2) The apparatus of claim 1, wherein said full flow filter media of said upper full flow filter section is made of a reusable cleanable metal mesh filtration media.

3) The apparatus of claim 1, wherein said spin on filter enclosure is a reusable spin on filter enclosure allowing for the removal, cleaning, and replacing of said upper full flow filter section.

4) The apparatus of claim 1, wherein a bypass valve is provided at said upper full flow filter section top closed end.

5) The apparatus of claim 1, wherein said plurality of full flow restriction control orifices collective area is smaller than the area of said normally provided engine discharge flow area and said full flow restriction control orifices collective area is within the range of 10 percent to 99 percent of said normally provided engine discharge flow area.

6) The apparatus of claim 1, wherein said advanced filtration media is a high efficiency filtering media, an advanced filtration media, rated within a range from below 1 micron to 50 microns in cross-sectional area and endowed with time released chemicals and additives.

7) The apparatus of claim 1, wherein the filtration efficiencies of the upper full flow filter section and lower advanced filtration filter section are the same or different.

8) An advanced and full flow filtration hybrid filter apparatus, said apparatus comprising:
an upper full flow filter section, said upper full flow filter section normally shaped as a thick-walled cylinder made with a full flow filter media having a top closed end and an upper full flow section bottom open end, said upper full flow filter section having an upper upstream external full flow filter surface and an upper downstream internal full flow filter surface,
a lower advanced filtration filter section, said lower advanced filtration filter section normally shaped as a thick-walled cylinder made with an advanced filtration media having a lower filter section top open end and a lower filter section bottom open end, said lower advanced filtration filter section having a lower upstream external advanced filtration filter surface and a lower downstream internal advanced filtration filter surface,
a hybrid filter filtration element generated by having said upper full flow section bottom open end sealingly biased against said lower advanced filtration filter section top open end, said hybrid filter filtration element having an upstream filter surface, said hybrid filter filtration element having a downstream internal filter surface,
a flexible pressure biasing membrane substantially shaped as a flat disc having a centrally located orifice restrictor, said flexible pressure biasing membrane sandwiched sealingly between said upper full flow section bottom open end and said lower advanced filtration filter section top open end,
a spin on filter enclosure having a cylindrical internal wall,
said flexible pressure biasing membrane projecting a circumferential periphery radially outward beyond the plane of said upstream filter surface until making contact and sealingly abutting against said cylindrical internal wall of said spin on filter enclosure,
wherein during operation a normally provided engine lubricant flow is injected into said spin on filter enclosure splitting into a parallel full flow lubricant flow and a parallel advanced filtration lubricant flow, said full flow lubricant flow generating a set of differential pressure contributors, a first differential pressure contributor while flowing through said flexible pressure biasing membrane, a second differential pressure contributor while flowing through said upper full flow filter section, a third differential pressure contributor while flowing through said centrally located orifice restrictor, thereby said set of differential pressure contributors generating a net differential pressure across said lower advanced filtration filter section, said net differential pressure promoting said parallel advanced filtration lubricant flow across said lower advanced filtration filter section, said parallel full flow lubricant flow and said advanced filtration lubricant flow forming and returning a reconstituted engine lubricant flow to a normally provided engine discharge flow area whereby simultaneous full flow and advanced filtration of said normally provided engine lubricant flow is accomplished.

9) The apparatus of claim 8, wherein said full flow filter media of said upper full flow filter section is made of a reusable cleanable metal mesh filtration media.

10) The apparatus of claim 8, wherein said spin on filter enclosure is a reusable spin on filter enclosure allowing for the removal, cleaning, and replacing of said upper full flow filter section.

11) The apparatus of claim 8, wherein said centrally located orifice restrictor area is smaller than said normally provided engine discharge flow area and chosen from a range of 10 percent to 99 percent of said normally provided engine discharge flow area.

12) The apparatus of claim 8, wherein a bypass valve is provided at said upper full flow filter section top closed end.

13) The apparatus of claim 8, wherein said advanced filtration media is a high efficiency filtering media, an advanced filtration media, rated within a range of 1 micron to 50 microns in cross-sectional area and endowed with time released chemicals and additives.

14) The apparatus of claim 8, wherein the efficiencies of the upper full flow filter section and lower advanced filtration filter section are the same or different.

15) The apparatus of claim 8, wherein said perforated inner tube in claim 1 is included in the apparatus of claim 9 thereby adding a fourth differential pressure generator.

16) The apparatus of claim 8, wherein said centrally located orifice restrictor inherently generates a Venturi effect at said lower downstream internal advanced filtration filter surface, thereby generating a fifth differential pressure contributor.

17) An advanced and full flow filtration hybrid filter apparatus, said apparatus comprising:
an upper full flow filter section, said upper full flow filter section normally shaped as a thick-walled cylinder made with a full flow filter media having a top open end and an upper full flow section bottom open end, said upper full flow filter section having an upper upstream external full flow filter surface and an upper downstream internal full flow filter surface,
a lower advanced filtration filter section, said lower advanced filtration filter section normally shaped as a thick-walled cylinder made with an advanced filtration media having a lower filter section top open end and a lower filter section bottom open end, said lower advanced filtration filter section having a lower upstream external advanced filtration filter surface and a lower downstream internal advanced filtration filter surface,
a hybrid filter filtration element generated by having said upper full flow section bottom open end sealingly biased against said lower advanced filtration filter section top open end shaped as a thick-walled cylinder having a central bore, said hybrid filter filtration element having an upstream filter surface, said hybrid filter filtration element having a downstream internal filter surface,
a perforated inner tube contiguously and sealingly disposed inside said open bore and disposed against said hybrid filtration element downstream internal filter surface, having a plurality of full flow restriction control orifices located contiguous to said upper downstream internal full flow filter surface and a plurality of advanced filtration restriction control orifices located contiguous to said lower downstream internal advanced filtration filter surface,
a flexible pressure biasing membrane substantially shaped as a flat disc having a centrally located bore matching said open bore diameter, said flexible pressure biasing membrane sealingly sandwiched between said upper full flow section bottom open end and said lower advanced filtration filter section top open end,
a normally provided engine cartridge filter enclosure having an cylindrical internal wall,
said flexible pressure biasing membrane projecting a circumferential periphery radially outward beyond the plane of said upstream filter surface until making contact and sealingly abutting against said normally provided engine cartridge enclosure cylindrical internal wall,
wherein during operation a normally provided engine lubricant flow is injected into said normally provided engine cartridge filter enclosure splitting into a parallel full flow lubricant flow and a parallel advanced filtration lubricant flow, said parallel full flow lubricant flow generating a set of differential pressure contributors, a first differential pressure contributor while flowing through said flexible pressure biasing membrane, a second differential pressure contributor while flowing through said upper full flow filter section, a third differential pressure contributor while flowing through said perforated inner tube, thereby said set of differential pressure contributors generating a net differential pressure across said lower advanced filtration filter section, said parallel full flow lubricant flow and said advanced filtration lubricant flow forming and returning a reconstituted engine lubricant flow to a normally provided engine discharge flow area whereby simultaneous full flow and advanced filtration of said normally provided engine lubricant flow is accomplished.

18) The apparatus of claim 17, wherein said full flow filter media of said upper full flow filter section is made of a reusable cleanable metal mesh filtration media.

19) The apparatus of claim 18, wherein said plurality of full flow restriction orifices collective area is smaller than said normally provided engine discharge flow area.
